(19) United States
(12) Patent Application Publication
(10) Pub. No.: US 2026/0319268 A1
(43) Pub. Date: Oct. 15, 2026

(54) EYEWEAR AND SYSTEMS AND METHODS OF MOUNTING OBJECTS THERETO

(71) Applicant: Thomas Eugene Pinkney, Savannah, GA (US)

(72) Inventor: Thomas Eugene Pinkney, Savannah, GA (US)

(21) Appl. No.: 19/462,897

(22) Filed: Jan. 28, 2026

Related U.S. Application Data
(60) Provisional application No. 63/750,362, filed on Jan. 28, 2025.

(51) Int. Cl. G02C 5/14; G02C 5/00; G02C 11/00

(52) U.S. Cl. CPC G02C 5/14; G02C 5/008; G02C 11/00

(57) ABSTRACT

Aspects of the present disclosure describe eyewear, for example safety eyewear, and systems and methods of mounting objects, for example marking tools such as pencils, etching devices, etc., thereto and kits including magnetic marking tool sleeves configured to adhere to magnetic temple portions of eyewear.

### CROSS-REFERENCE TO RELATED APPLICATIONS

The present application claims the benefit of U.S. Provisional Patent Application Ser. No. 63/750,362, filed Jan. 28, 2025, the entire contents of which are specifically incorporated herein by reference.

### FIELD

The present technology is generally related to eyewear, and more particularly to eyewear, such as safety eyewear, and systems and methods of mounting objects, for example pencils, etching devices, etc., thereto.

### BACKGROUND

There are many types of eyewear, e.g., glasses, goggles, masks, etc., including safety eyewear, which is useful to protect a user's eyes during activities such as carpentry, electrical work, plumbing, general use, etc. Typically, glasses will have arms that extend back from an eyeglass frame and past the temple to secure the glasses to a user's head. Goggles and masks may also have a rigid or semi-rigid component or a combination of frame and flexible strap, e.g., passing the temple region of the user, to secure the goggles in place. Such securement of the eyewear to the head allows the user to use other implements while wearing the eyewear by freeing up the user's hands to access pockets or pouches, etc.

The present disclosure recognizes that there is a need in the art for eyewear, and in exemplary aspects, safety eyewear that provides additional functionality beyond securing the eyewear to the head.

### SUMMARY

The techniques of this disclosure generally relate to eyewear, and more particularly and advantageously to eyewear and systems and methods of mounting objects, for example marking tools such as pencils, etching devices, etc., thereto.

In an exemplary aspect of the present disclosure, the eyewear is safety eyewear and has a side frame or arm portion that includes at least one magnet provided on or in a surface thereof. This enables another magnetic object or a ferromagnetic material to adhere to that surface. In exemplary aspects, the side frame or arm portion is at least one temple arm, with the at least one magnet provided on or in the temple arm.

In further exemplary aspects, a temple arm of safety eyewear has at least one magnet embedded in the temple arm. In additional exemplary aspects, plural magnets are embedded in the temple arm, providing a linear portion along the temple arm to adhere another magnetic item or a ferromagnetic material. In exemplary embodiments, the temple arms are configured with a width and depth sized to hold at least one magnetic linear array of magnets therein.

In further exemplary aspects, at least one magnet is provided within each of both temple arms of safety eyewear. In additional exemplary aspects, plural magnets are provided within each of both temple arms, providing linear portions on either side of a user's head configured to adhere magnetic or ferromagnetic items thereto.

In further exemplary embodiments, a kit is provided with safety eyewear as described in exemplary aspects herein having at least one magnet thereon or therein, along with at least one magnetic or ferromagnetic sleeve that is sized and configured to hold an item, e.g., one of a number 2 pencil or a carpenter's pencil. In further exemplary embodiments, a kit is provided with plural accessory sleeves having different channel shapes or sizes to accommodate different item geometries, e.g., a number 2 pencil and a carpenter's pencil. In other exemplary embodiments, a kit includes safety eyewear and at least one magnetic or ferromagnetic pencil.

In other exemplary embodiments, safety eyewear includes two temple arms, with at least one temple arm including a fold-away clip, either integral with or attached thereto, configured to expand out from an outer surface thereof to hold an item, e.g., a number 2 pencil, and to fold back down to the surface of the temple arm when not in use. In further exemplary embodiments, safety eyewear includes one magnetic temple and one temple having a fold-away clip.

Advantageously, exemplary embodiments disclosed herein provide for magnetic and/or non-magnetic mounting of marking tool(s) on side or temple portions of eyewear, including e.g., safety eyewear, eliminating the need for pockets to store such marking tools and keeping those marking tools near the line of vision during work. This advantageously allows a user that might be e.g. in a crawlspace or on a latter to keep their eyes on the project target while grabbing a marking tool to use thereon, and to quickly re-mount the marking tool to the safety eyewear immediately after use.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a front perspective view of exemplary safety eyewear including magnetic temple arms, in accordance with exemplary aspects of the present disclosure;

FIG. 2 is side elevation view of the safety eyewear illustrated in FIG. 1;

FIG. 3 is a front perspective view of the safety eyewear of FIG. 1 showing a number 2 pencil mounted via a magnetic sleeve sized for the number 2 pencil on one temple piece, and a carpenter's pencil mounted via a magnetic sleeve sized for the carpenter's pencil on the other temple piece, in accordance with exemplary aspects of the present disclosure;

FIG. 4 is a side elevation view of the safety eyewear having pencils mounted thereto shown in FIG. 3;

FIG. 5 is a front elevation view of the individual components shown in FIGS. 3 and 4, including safety eyewear and different magnetic sleeves configured for a number 2 pencil and a carpenter's pencil, in accordance with exemplary aspects of the present disclosure;

FIG. 6 is a rear perspective view of exemplary safety eyewear with non-magnetic fold-away clips in an extended position, in accordance with exemplary aspects of the present disclosure;

FIG. 7 is a rear perspective of the exemplary eyewear of FIG. 6 with the fold-away clips in a retracted position, in accordance with exemplary aspects of the present disclosure;

FIG. 8 is a side perspective view of the exemplary eyewear of FIG. 6, with the extended fold-away clips holding a number 2 pencil; and

FIG. 9 is a front perspective view of the exemplary eyewear of FIG. 8.

### DETAILED DESCRIPTION

As we have noted, the techniques of this disclosure generally relate to generally relate to eyewear, and more particularly and advantageously to eyewear, including e.g., safety eyewear, and systems and methods of mounting objects, for example marking tools such as pencils, etching devices, etc., thereto. Exemplary mounting devices described herein include mounting devices using various of mechanical or magnetic forces for mounting devices, e.g., via one or more of magnets, clips, hook and loop attachment devices, etc.

In an exemplary aspect of the present disclosure, eyewear has a side frame or arm portion that includes at least one magnet provided on or in, e.g., embedded in, a surface thereof. This enables another magnetic object or a ferromagnetic material to adhere to that surface. In exemplary aspects, the side frame or arm portion is at least one temple arm, with the at least one magnet provided on or in the temple arm.

In further exemplary aspects, a temple arm of safety eyewear has at least one magnet embedded in the temple arm. In additional exemplary aspects, plural magnets are embedded in the temple arm, providing a linear portion along the temple arm to adhere another magnetic item or a ferromagnetic material. In exemplary embodiments, the temple arms are configured with a width and depth sized to hold at least one magnetic linear array of magnets therein.

In exemplary embodiments, at least one temple arm has a size including a thickness and a height configured to contain one or more magnets therein, and configured to mount a magnetic or ferromagnetic sleeve having a size configured to hold a number 2 pencil or a carpenter's pencil. In exemplary embodiments, the size the at least one magnet is an inch in length, having a flat profile, wherein the temple arm has a width, length (e.g., more than one inch) and height (e.g., 12-13 millimeters (mm) or more, though the temple arm may taper after the magnet) greater than the magnet in order to allow the magnet to be provided therein. In further exemplary embodiments, the at least one magnet is provided in a forward portion of the temple arm, near the frame of the safety eyewear, in order to mount the magnetic or ferromagnetic object (e.g., marking tool) at least partially in the eyesight of the user.

In exemplary aspects, one or both of the safety eyewear and the temple is a durable plastic, e.g., acrylonitrile butadiene styrene (ABS), though other materials may be utilized.

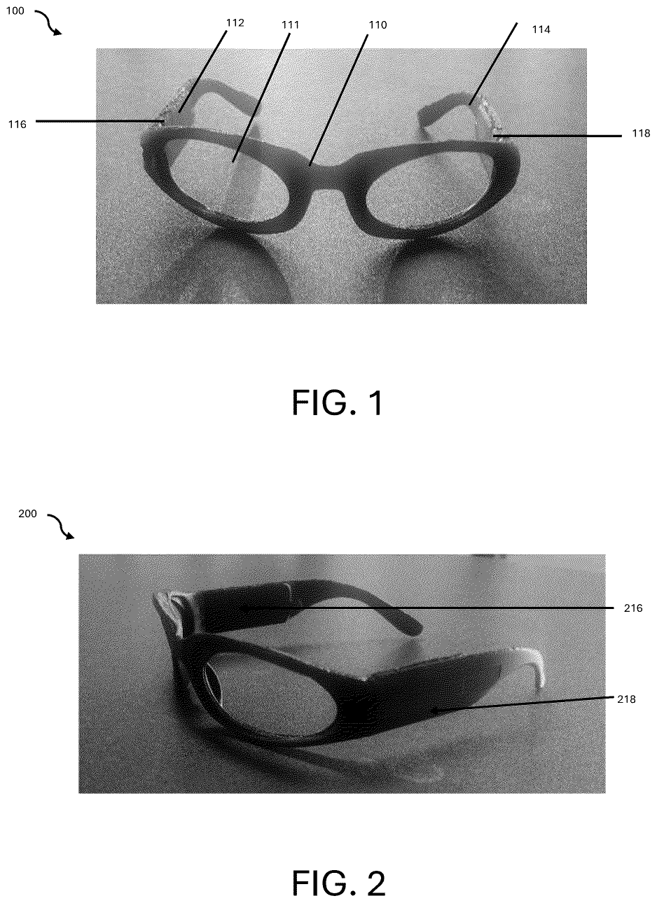

Referring now to FIG. 1, safety eyewear in accordance with exemplary embodiments of the disclosure is shown generally at 100 and includes a frame 110, at least one safety lens 111 and temple arms 112, 114. In this illustrated exemplary embodiment, temple arm magnet housing portions 116, 118 include at least one embedded magnet each.

FIG. 2 illustrates the exemplary safety eyewear of FIG. 1, showing an exemplary height, thickness and length for each temple arm magnet housing portion 216, 218 sufficient to house at least one embedded magnet (where the magnet is flat and approximately one inch long).

In further exemplary aspects, at least one magnet is provided within each of both temple arms of safety eyewear. In additional exemplary aspects, plural magnets are provided within each of both temple arms, providing linear portions on either side of a user's head configured to adhere magnetic or ferromagnetic items thereto.

In further exemplary embodiments, a kit is provided with safety eyewear as described in exemplary aspects herein having at least one magnet thereon or therein, along with at least one magnetic or ferromagnetic sleeve that is sized and configured to hold an item, e.g., one of a number 2 pencil or a carpenter's pencil. In further exemplary embodiments, a kit is provided with plural accessory sleeves having different channel shapes or sizes to accommodate different item geometries, e.g., a number 2 pencil (e.g., 6-8 millimeters (mm) hexagonal diameter and 6-7 mm hexagonal height) and a carpenter's pencil (e.g., 6-7 mm in one cross sectional dimension and 12-13 mm in a second cross sectional dimension). In other exemplary embodiments, a kit includes safety eyewear and at least one magnetic or ferromagnetic pencil.

In exemplary embodiments, the sleeve or sleeves are approximately two inches in length and have an interior dimension configured to approximate the standard number 2 pencil cross-sectional outer dimensions or the cross-sectional outer dimensions of a standard carpenter's pencil. While a length of two inches is shown, the length may be greater or shorter, e.g., 1-3 inches, etc. In an exemplary embodiment for a number 2 pencil sleeve, an exemplary sleeve length is 1½ inches, with an internal diameter of ¼ inch×¼ inch. In an exemplary embodiment for a carpenter pencil, an exemplary sleeve length is 1½ inches with an internal diameter of ½ inch×½ inch.

In further exemplary embodiments, at least one wall of the sleeve or sleeves has a thickness configured to house one or more magnets provided, e.g., embedded, provided within an overmold, etc., therein. In further exemplary embodiments, the sleeves are a durable plastic, e.g., ABS.

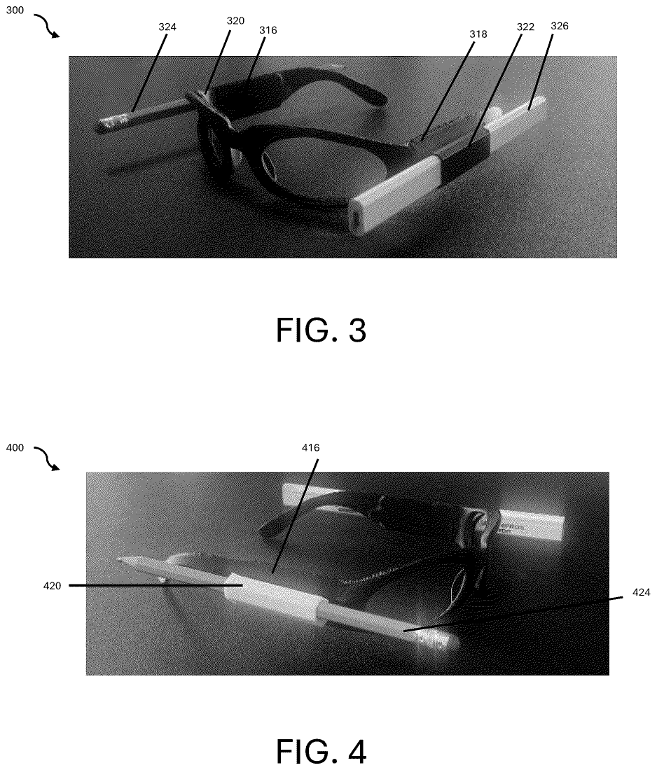

FIG. 3 illustrates the exemplary safety eyewear of FIGS. 1 and 2 generally at 300, with two different magnetic sleeves 320, 322 holding two different marking tools 324 (a number 2 pencil) and 326 (a carpenter's pencil) to the temple arm magnet housing portions 316 and 318, respectively.

FIG. 4 illustrates (generally at 400) the magnetic attachment of magnetic sleeve 420 for the number 2 pencil 424 to the temple arm magnet housing portion 416 more clearly, as well as illustrating a portion of the pencil 424 extending forward to be at least partially in the view of a user when mounted.

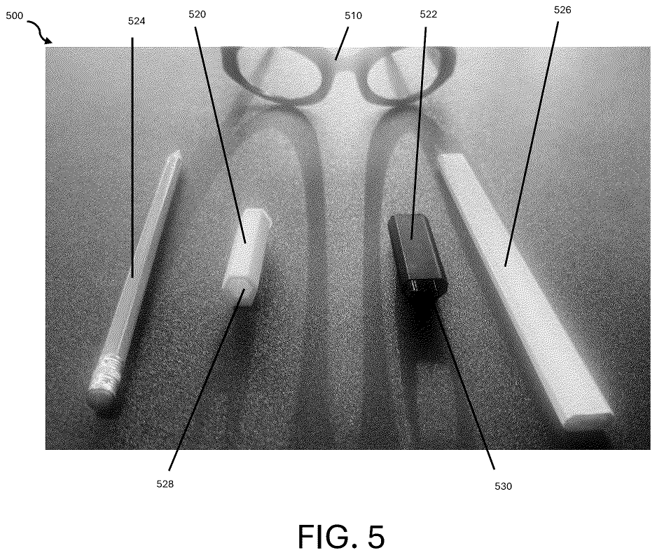

FIG. 5 illustrates (generally at 500) the elements of FIGS. 3 and 4 in an exemplary kit form, including safety eyewear 510, first and second sleeves 520, 522 and respective sleeve marking tools 524 (number 2 pencil) and 526 (carpenter's pencil). The interior bores 528, 530 of the respective sleeves have dimensions complementary to the exterior shapes of the marking tools 524 and 526, respectively.

In other exemplary embodiments, safety eyewear includes two temple arms, with at least one temple arm including a fold-away clip, either integral with or attached thereto, configured to expand out from an outer surface thereof to hold an item, e.g., a number 2 pencil, and to fold back down, e.g., flat to the surface of the temple arm, when not in use. In further exemplary embodiments, safety eyewear includes one magnetic temple and one temple having a fold-away clip.

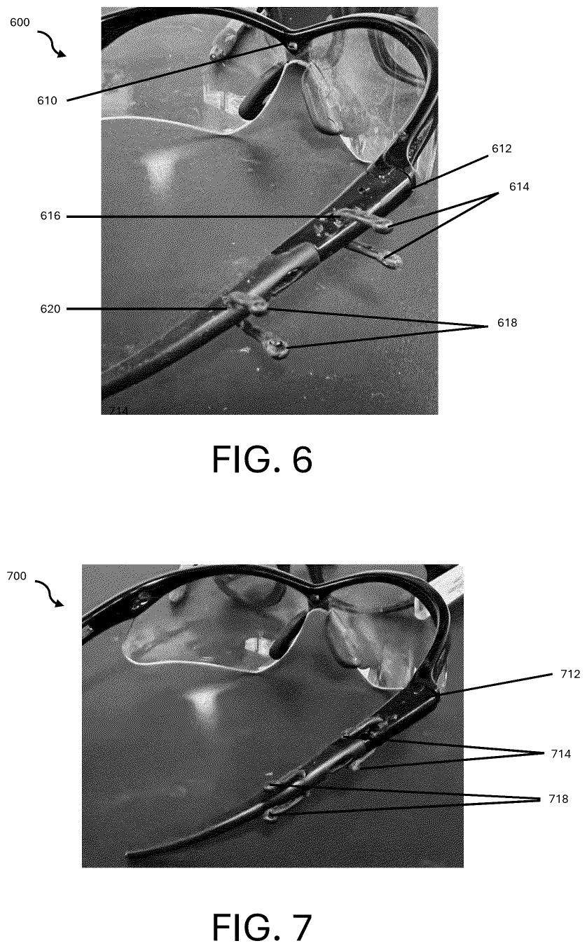

FIG. 6 illustrates an example of the fold-away clip form of safety eyewear generally at 600, including the eyewear frame 610 and at least one eyewear temple arm 612 including first and second pairs of fold-away clips 614, 618, each having upper and lower retaining arms connected to the temple arm at 616 and 620, respectively.

FIG. 7 illustrates generally at 700 the safety eyewear of FIG. 6, with first and second pairs of fold-away clips 714, 718 folded flush with the surface of the temple arm 712, providing a streamlined temple profile when the pairs of fold-away clips are not being used.

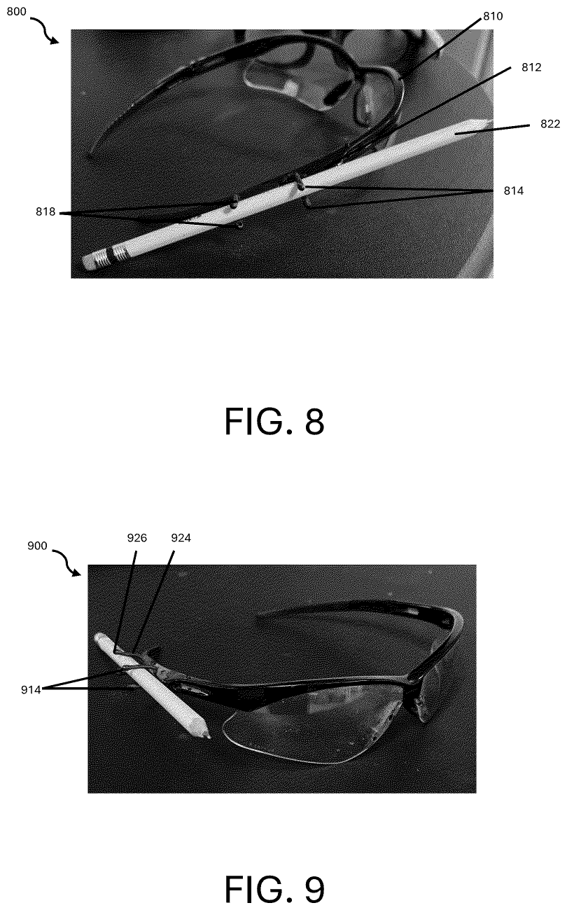

FIG. 8 illustrates generally at 800 the safety eyewear of FIG. 7, including the frame 810, temple arm 812 and first and second pairs of fold-away clips 814, 818, with a marking tool 822 (a number 2 pencil, for example) being held by the pairs of the fold-away clips.

FIG. 9 illustrates generally at 900 the safety eyewear of FIG. 8 in a different perspective. In further exemplary embodiments, at least one of any individual arm 924 for arm pairs 914 (818 is not labeled in FIG. 9 as 918 in order to better view the individual arm 924) is flexible (e.g., bendable metal) such that they can be shaped to accommodate the size of the marking tool desired to be held. In further exemplary embodiments, at least one individual arm 924 further includes a contoured tip 926 to provide additional surface area to retain the marking tool.

Advantageously, exemplary embodiments disclosed herein provide for magnetic and/or non-magnetic mounting of marking tool(s) on side or temple portions of eyewear, including e.g., safety eyewear, eliminating the need for pockets to store such marking tools and keeping those marking tools near the line of vision during work. This advantageously allows a user that might be e.g. in a crawlspace or on a latter to keep their eyes on the project target while grabbing a marking tool to use thereon, and to quickly re-mount the marking tool to the eyewear immediately after use.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit, or individual or example materials, for purposes of clarity, it should be understood that the techniques of this disclosure may be performed by a combination of different of units, modules or materials associated with, for example, eyewear having removable or replaceable magnetic or non-magnetic mounting components, such as replaceable temple arms.

What is claimed is:

1. Eyewear, comprising:
a frame, at least one lens, and a temple side component extending back from the frame,
wherein the temple side component includes a mechanical or magnetic attachment device configured to retain a marking tool against the temple side surface via the mechanical or magnetic attachment device.

2. Eyewear in accordance with claim 1, wherein the temple side component is at least one temple arm, and wherein the at least one temple arm includes at least one magnet provided thereon or therein.

3. Eyewear in accordance with claim 2, wherein the at least one magnet is embedded in a portion of the at least one temple arm.

4. Eyewear in accordance with claim 3, wherein the eyewear includes two temple arms, with each temple arm including at least one magnet thereon or therein.

5. Eyewear in accordance with claim 4, wherein at least one magnet is embedded in a portion of each temple arm proximate to the frame.

6. Eyewear in accordance with claim 1, wherein the temple side component is at least one temple arm, and wherein the at least one temple arm includes at least one pair of fold-away clips configured to retain a marking tool therebetween.

7. Eyewear in accordance with claim 6, wherein the at least one temple arm includes at least two pairs of fold-away clips configured to retain the marking tool.

8. Eyewear in accordance with claim 7, wherein the at least two pairs of fold-away clips are configured to extend outwardly away from the at least one temple arm to retain the marking tool and to fold against at least one surface of the at least one temple arm when not in use.

9. Eyewear in accordance with claim 8, wherein the at least two pairs of fold-away clips rotate through respective holes provided in the at least one temple arm to swing end portions of the at least two pairs of fold-away clips backwards along the at least one temple and against surfaces of the at least one temple arm.

10. Eyewear in accordance with claim 9, wherein the holes are configured with a friction fit against at least one midpoint between each pair of fold-away clips in order to at least partially hold each pair of fold-away clips in an extended position during use.

11. Eyewear in accordance with claim 7, wherein the eyewear includes two temple arms, with each temple arm including at least two pairs of fold-away clips configured to retain a marking tool for each temple arm.

12. Eyewear in accordance with claim 8, wherein at least one arm portion of the at least two pairs of fold-away clips is bendable into a position to optimize retention of the marking tool.

13. Eyewear in accordance with claim 12, wherein an end portion of the at least one arm portion includes a contour to optimize retention of the marking tool.

14. An eyewear kit, comprising:
a frame;
at least one lens;
a temple side surface extending back from the frame, wherein the temple side surface includes at least one magnet provided on or in the temple side surface; and
at least one magnetic or ferromagnetic sleeve,
wherein the magnet in the temple side surface is configured along with the at least one magnetic or ferromagnetic sleeve to retain a marking tool against the temple side surface.

15. An eyewear kit in accordance with claim 14, wherein the sleeve is a magnetic sleeve having an interior channel configured to engage and retain the marking tool.

16. An eyewear kit in accordance with claim 14, wherein the kit includes at least two magnetic sleeves having different channel dimensions configured to retain different marking tools having different outer geometries.

17. An eyewear kit in accordance with claim 16, wherein the eyewear temple side surface comprises two temple arms.

18. An eyewear kit in accordance with claim 17, wherein both temple arms include at least one magnet embedded therein.

19. An eyewear kit in accordance with claim 17, wherein one temple arm includes at least one magnet embedded therein and a second temple arm includes at least one fold-away clip configured to retain a marking tool.

20. An eyewear kit in accordance with claim 19, wherein the second temple arm includes plural fold-away clips configured to retain a marking tool.
